(19) United States
(12) Patent Application Publication
(10) Pub. No.: US 2025/0123118 A1
(43) Pub. Date: Apr. 17, 2025

(54) MAP GENERATION DEVICE AND MAP GENERATION METHOD

(71) Applicant: JVCKENWOOD Corporation, Yokohama-shi (JP)

(72) Inventor: Yasutoshi Sakai, Yokohama-shi (JP)

(21) Appl. No.: 18/985,105

(22) Filed: Dec. 18, 2024

Related U.S. Application Data
(63) Continuation of application No. PCT/JP2023/023045, filed on Jun. 22, 2023.

(30) Foreign Application Priority Data
Jun. 27, 2022 (JP) 2022-102736

(51) Int. Cl. G01C 21/00

(52) U.S. Cl. CPC G01C 21/3841; G01C 21/3848

(57) ABSTRACT

A map generation device includes: an information acquisition unit that acquires positional information on a specific vehicle and positional information on a surrounding vehicles that is positioned around the specific vehicle from on-board devices that are arranged respectively on the specific vehicle and the surrounding vehicle, respectively; a map integration unit that integrates an information being on a surrounding object and having been acquired from the on-board device determined on the basis of degrees of agreement between the positional information on the specific vehicles detected by the on-board devices mounted in the specific vehicles and the positional information on the specific vehicles detected by the on-board devices mounted in the surrounding vehicles.

### CROSS-REFERENCE TO RELATED APPLICATIONS

This application is a Continuation of PCT International Application No. PCT/JP2023/023045 filed on Jun. 22, 2023 which claims the benefit of priority from Japanese Patent Application No. 2022-102736 filed on Jun. 27, 2022, the entire contents of both of which are incorporated herein by reference.

### BACKGROUND OF THE INVENTION

### 1. Field of the Invention

The present disclosure relates to a map generation device and a map generation method.

### 2. Description of the Related Art

A technology of generating a map based on images that are captured by image capturing devices mounted on vehicles has been known. Japanese Laid-open Patent Publication No. 2020-197708 discloses a technology of generating a map by performing weighting based on imbalance in data of images that are transmitted from image capturing devices and integrating the data.

According to the technology according to Japanese Laid-open Patent Publication No. 2020-197708reliability of the data is evaluated on the basis of information related to landmarks and priority of the data to be used in generation of the map is set on the basis of the reliability. Therefore, the technique of Japanese Unexamined Patent Application Publication No. 2020-197708 may not enable a map to be generated adequately in a case where objects recognizable as landmarks are unavailable.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A map generation device according to the present disclosure comprising: an information acquisition unit that acquires positional information on a specific vehicle and positional information on a surrounding vehicles that is positioned around the specific vehicle from on-board devices that are arranged respectively on the specific vehicle and the surrounding vehicle, respectively;
a map integration unit that integrates an information being on a surrounding object and having been acquired from the on-board device determined on the basis of degrees of agreement between the positional information on the specific vehicles detected by the on-board devices mounted in the specific vehicles and the positional information on the specific vehicles detected by the on-board devices mounted in the surrounding vehicles.

A map generation method according to the present disclosure comprising: acquiring positional information on a specific vehicles and positional information on a surrounding vehicles that is positioned around the specific vehicle from on-board devices that are arranged respectively on the specific vehicle and the surrounding vehicle, respectively; integrating an information being on a surrounding object and having been acquired from the on-board device determined on the basis of degrees of agreement between the positional information on the specific vehicles detected by the on-board devices mounted in the specific vehicles and the positional information on the specific vehicles detected by the on-board devices mounted in the surrounding vehicles.

### BRIEF DESCRIPTION OF THE DRAWINGS

FIG. 1 illustrates an example of a configuration of a map generation system according to an embodiment;

FIG. 2 is a block diagram illustrating an example of a configuration of an on-board device according to the embodiment;

FIG. 3 is a diagram illustrating an example of a configuration of a map generation device according to the embodiment;

FIG. 4 is a flowchart illustrating a flow of a map generation process according to the embodiment;

FIG. 5 is a diagram illustrating a method of acquiring vehicle information, according to the embodiment;

FIG. 6 is a diagram illustrating a method of calculating a difference between pieces of positional information, according to the embodiment;

FIG. 7 is a diagram illustrating a method of calculating a difference between pieces of positional information, according to the embodiment;

FIG. 8 is a diagram illustrating a method of calculating a difference between pieces of positional information, according to the embodiment;

FIG. 9 is a diagram illustrating a method of placing surrounding objects on a map, according to the embodiment; and

FIG. 10 is a diagram illustrating a method of placing surrounding objects on a map, according to a modified example of the embodiment.

### DETAILED DESCRIPTION OF THE PREFERRED EMBODIMENTS

An embodiment according to the present disclosure will hereinafter be described in detail by reference to the appended drawings. The present disclosure is not to be limited by the embodiment. With respect to the following embodiment, any redundant description will be omitted by assignment of the same reference sign to any parts that are the same.

### Embodiment

### Map Generation System

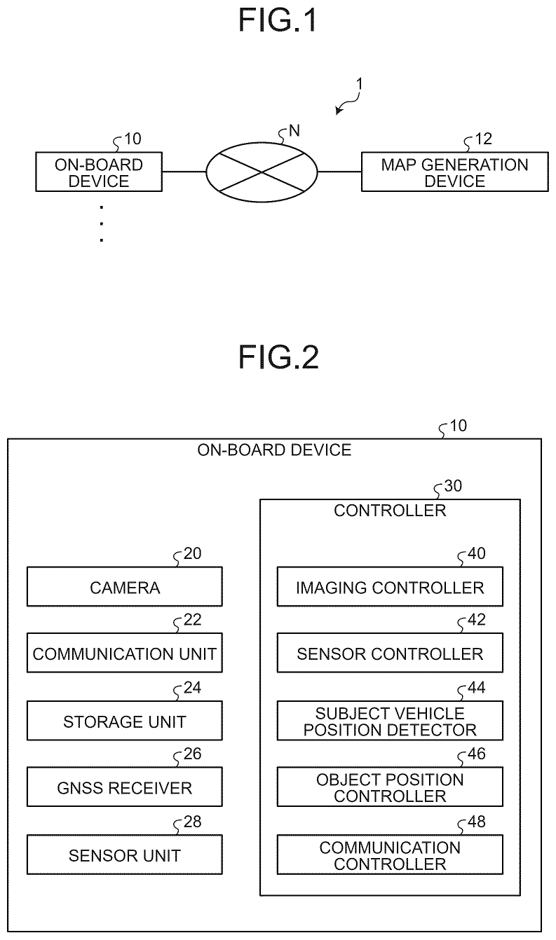

A map generation system according to an embodiment will be described by use of FIG. 1. FIG. 1 illustrates an example of a configuration of the map generation system according to the embodiment.

As illustrated in FIG. 1, a map generation system 1 includes a plurality of on-board devices 10 and a map generation device 12. The on-board devices 10 and the map generation device 12 are connected via a network N such that they are able to communicate with each other. The map generation system 1 is a system in which the map generation device 12 increases priority of accurate positional information based on positional information on a specific vehicle that is detected by the on-board device 10 mounted on a vehicle and positional information on another vehicle and generates a dynamic map.

### On-Board Device

An example of a configuration of an on-board device according to the embodiment will be described by use of FIG. 2. FIG. 2 is a block diagram illustrating the example of the configuration of the on-board device according to the embodiment.

As illustrated in FIG. 2, the on-board device 10 includes a camera 20, a communication unit 22, a storage unit 24, a GNSS (Global Navigation Satellite System) receiver 26, a sensor unit 28, and a controller 30. The on-board device 10 is mounted on a vehicle. The on-board device 10 performs detection of positional information on its own vehicle and positional information on any object surrounding its own vehicle, the latter positional information including positional information on any surrounding vehicle surrounding its own vehicle. The on-board device 10 transmits a result of the detection of the positional information on its own vehicle and the positional information on any object surrounding its own vehicle, to the map generation device 12.

The camera 20 is a camera that captures an image of surroundings of the vehicle. The camera 20 is, for example, a camera that captures a moving image at a predetermined frame rate. The camera 20 may be a single lens camera or a stereo camera. The camera 20 may be a single camera or a group of plural cameras. The camera 20 includes a forward camera that captures an image of a region in front of the vehicle, a right camera that captures an image of a region on a right side of the vehicle, a left camera that captures an image of a region on a left side of the vehicle, and a backward camera that captures a region in back of the vehicle. For example, the camera 20 constantly captures images of surroundings of the vehicle while the vehicle is operating.

The communication unit 22 executes communication between the on-board device 10 and an external device. For example, the communication unit 22 executes communication between the on-board device 10 and the map generation device 12. The communication unit 22 is realized using a communication module that performs communication according to communication standards, such as 4G (4th Generation) and 5G (5th Generation).

The storage unit 24 stores various kinds of information. The storage unit 24 stores information, such as content of calculation by the controller 30 and programs. The storage unit 24 includes, for example, at least one selected from a group including: main storages, such as a random access memory (RAM) or a read only memory (ROM); and an external storage, such as a hard disk drive (HDD).

The GNSS receiver 26 includes a GNSS receiver that receives GNSS signals from GNSS satellites. The GNSS receiver 26 outputs the GNSS signals received, to a subject vehicle position detector 44 of the controller 30.

The sensor unit 28 includes various sensors. The sensor unit 28 detects sensor information that enables identification of a state of the vehicle that the on-board device 10 is mounted in. The sensor unit 28 may use, for example, sensors, such as a position sensor, a gyro sensor, and an acceleration sensor. Examples of the position sensor include: a laser radar that detects a distance from any surrounding object (for example, a laser imaging detection and ranging (LIDAR) sensor); an infrared sensor including an infrared irradiation unit and a light receiving sensor; and a Time-of-Flight (ToF) sensor. The position sensor may be implemented by a combination of any plural ones of a gyro sensor, an acceleration sensor, a laser radar, an infrared sensor, and a ToF sensor, and may be implemented by a combination of all of these sensors.

The controller 30 controls each unit of the on-board device 10. The controller 30 has, for example, an information processing device, such as a central processing unit (CPU) or a micro processing unit (MPU), and a storage device, such as a RAM or a ROM. The controller 30 may be implemented by, for example, an integrated circuit, such as an application specific integrated circuit (ASIC) or a field programmable gate array (FPGA). The controller 30 may be implemented by a combination of hardware and software.

The controller 30 includes an imaging controller 40, a sensor controller 42, the subject vehicle position detector 44, an object position detector 46, and a communication controller 48.

The imaging controller 40 controls the camera 20 to cause the camera 20 to capture images of surroundings of their own vehicle. The imaging controller 40 acquires video data that the imaging controller 40 has caused the camera 20 to capture.

The sensor controller 42 controls the sensor unit 28 to cause the sensor unit 28 to detect a state of their own vehicle. The sensor controller 42 acquires sensor information indicating the state of its own vehicle, the state being the state the sensor controller 42 has caused the sensor unit 28 to detect.

The subject vehicle position detector 44 detects a position of its own vehicle that the on-board device 10 has been mounted in (a position of the on-board device 10). The subject vehicle position detector 44 detects the position of its own vehicle that the on-board device 10 has been mounted in, on the basis of GNSS signals received by the GNSS receiver 26. The subject vehicle position detector 44 may detect the position of its own vehicle on the basis of, not only the GNSS signals, but also the sensor information acquired by the sensor controller 42. For example, the subject vehicle position detector 44 detects the position of its own vehicle on the basis of the GNSS signals received by the GNSS receiver 26 and a piece of information from the gyro sensor and a piece of information from the acceleration sensor, these pieces of information having been acquired by the sensor controller 42. The subject vehicle position detector 44 calculates, for example, global coordinates of its own vehicle on the basis of the GNSS signals.

The object position detector 46 detects positional information on any object positioned in a region surrounding its own vehicle, that is, positional information on any surrounding object. The object position detector 46 recognizes any object surrounding its own vehicle on the basis of the video data acquired by the imaging controller 40, measures a distance to the object recognized, and thereby detects positional information on the object surrounding its own vehicle. In a case where the camera 20 is a single lens camera, for example, the object position detector 46 detects the positional information on the object surrounding its own vehicle by using the Structure from Motion (SfM) method. The object position detector 46 may, for example, analyze behavior of the object surrounding its own vehicle by the SfM method and thereby calculate a position of the object after elapse of a predetermined time period. In a case where the camera 20 is a stereo camera, the object position detector 46 detects the positional information on the object surrounding its own vehicle by using the principle of triangulation. The object position detector 46 may detect the positional information on the object surrounding its own vehicle on the basis of, not only the video data, but also the sensor information acquired by the sensor controller 42. For example, the object position detector 46 detects the positional information on the object surrounding its own vehicle on the basis of the video data acquired by the imaging controller 40 and the piece of information from the gyro sensor and the piece of information from the acceleration sensor, these pieces of information having been acquired by the sensor controller 42.

The object position detector 46 detects, for example, positional information on a moving body that is moving in a region surrounding its own vehicle. The object position detector 46 detects, for example, positional information on a surrounding vehicle that is traveling in a region surrounding its own vehicle. The object position detector 46 detects, for example, positional information on a person who is moving around its own vehicle. The object position detector 46 detects, for example, positional information on a bicycle or a wheelchair that is moving in a region surrounding its own vehicle.

The communication controller 48 controls the communication unit 22 to control communication between the on-board device 10 and an external device. The communication controller 48 controls the communication unit 22 to control communication between the on-board device 10 and the map generation device 12. For example, the communication controller 48 transmits positional information on its own vehicle detected by the subject vehicle position detector 44, to the map generation device 12. The communication controller 48 transmits, for example, positional information on any surrounding object detected by the object position detector 46, to the map generation device 12.

### Map Generation Device

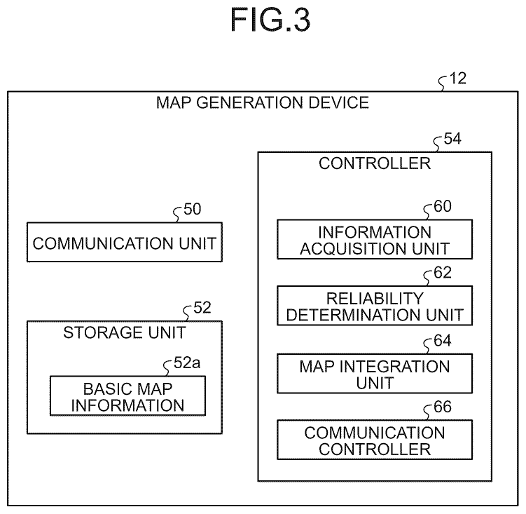

An example of a configuration of a map generation device according to the embodiment will be described by use of FIG. 3. FIG. 3 is a diagram illustrating the example of the configuration of the map generation device according to the embodiment.

As illustrated in FIG. 3, the map generation device 12 includes a communication unit 50, a storage unit 52, and a controller 54. The map generation device 12 is implemented by, for example, a server device arranged at a control center that controls the map generation system 1. The map generation device 12 is a device that generates a dynamic map on the basis of information acquired from the on-board devices 10.

The communication unit 50 executes communication between the map generation device 12 and an external device. For example, the communication unit 50 executes communication between the map generation device 12 and the on-board devices 10. The communication unit 50 is implemented by, for example, a communication module that performs communication by means of systems of 4th Generation (4G), 5th Generation (5G), a wireless LAN, and a wired LAN.

The storage unit 52 stores various kinds of information. The storage unit 52 stores information, such as content of calculation by the controller 54 and programs. The storage unit 52 includes, for example, at least one selected from a group including: main storages, such as a RAM and a ROM; and an external storage, such as an HDD.

The storage unit 52 stores basic map information 52a that serves as a base for generation of a dynamic map. The dynamic map generally refers to static map data having dynamic object data mapped onto the static map data, the dynamic object data being on pedestrians, automobiles, and traffic conditions. The basic map information 52a is static map data that are highly accurate. The map data include road information and building information, for example.

The controller 54 controls each unit of the map generation device 12. The controller 54 has, for example, an information processing device, such as a CPU or an MPU, and a storage device, such as a RAM or a ROM. The controller 54 may be implemented by, for example, an integrated circuit, such as an ASIC or an FPGA. The controller 54 may be implemented by a combination of hardware and software.

The controller 54 includes an information acquisition unit 60, a reliability determination unit 62, a map integration unit 64, and a communication controller 66.

The information acquisition unit 60 acquires various types of information from the on-board device 10 via the communication unit 50. The information acquisition unit 60 acquires, as the positional information on the specific vehicle, the positional information on the subject vehicle that is detected by each of the subject vehicle position detector 44 of the on-board devices 10 via the communication unit 50. The information acquisition unit 60 acquires, via the communication unit 50, positional information on surrounding objects that is detected by the object position detector 46 of each of the on-board devices 10 and that contains positional information on a surrounding vehicle positioned around the specific vehicle on which the on-board device 10 is mounted.

Information on each of a plurality of on-board devices 10 differs depending on the performance of each of cameras and sensors of the on-board devices 10 and therefore the reliability determination unit 62 determines reliability representing a degree of accuracy of each of the on-board devices 10 in detecting a surrounding object. Based on a degree of agreement between positional information on a vehicle that is detected by the on-board device 10 mounted on the vehicle and positional information on a vehicle that is detected by the on-board device 10 mounted on a surrounding vehicle around the vehicle, the reliability determination unit 62 determines reliability of the on-board device 10 mounted in the surrounding vehicle in detecting a surrounding object. For example, when the degree of agreement of positional information on a specific vehicle that is detected by the on-board device 10 mounted on a surrounding vehicle with positional information on the specific vehicle that is detected by the on-board device 10 mounted on the specific vehicle is hegher, the reliability determination unit 62 determines that the reliability of the on-board device 10 mounted on the surrounding vehicle in detecting a surrounding object is higher. This is because accuracy of the on-board device 10 in detecting a position of a specific vehicle based on GNSS signals is higher than accuracy in detecting a position of a surrounding vehicle based on video data.

The degree of reliability of an on-board device 10 can dynamically change due to, not only the performance of the device, but also the direction of sunshine when the vehicle is traveling, the surrounding brightness, the travel velocity of the vehicle, the weather, and any stain on a lens of the camera 20, for example. Therefore, the reliability determination unit 62 preferably determines a degree of reliability every time positional information is acquired from an on-board device 10. In other words, the reliability determination unit 62 preferably determines degrees of reliability of the on-board devices 10 constantly.

In a case where a load of processing for determination of a degree of reliability is large, for example, the reliability determination unit 62 may perform determination of a degree of reliability of an on-board device 10 at a predetermined point in time. For example, the reliability determination unit 62 may perform determination of a degree of reliability of an on-board device 10 when its vehicle stops at a red traffic light or due to a traffic jam. Performing determination of a degree of reliability of an on-board device 10 at a predetermined point in time enables reduction in the load of the processing.

The map integration unit 64 generates a dynamic map by integrating positional information on a specific vehicle acquired from its on-board device 10 and positional information on a surrounding object, with the basic map information 52a stored in the storage unit 52. The map integration unit 64 generates the dynamic map by integrating the positional information on the surrounding object acquired from the on-board device 10 determined on the basis of degrees of reliability being among the plurality of on-board devices 10 into the basic map information 52a. The map integration unit 64 generates the dynamic map by integrating the positional information on the surrounding object acquired from the on-board device 10 having the highest degree of reliability among the plural on-board devices 10 into the basic map information 52a. The map integration unit 64 may generate the dynamic map by integrating the positional information on the surrounding object acquired from the on-board device 10 having a degree of reliability higher than a predetermined threshold being among the plural on-board devices 10 into the basic map information 52a.

The communication controller 66 controls the communication unit 50 to control communication between the map generation device 12 and an external device. The communication controller 66 controls the communication unit 50 to control communication between the map generation device 12 and the on-board devices 10.

### Map Generation Process

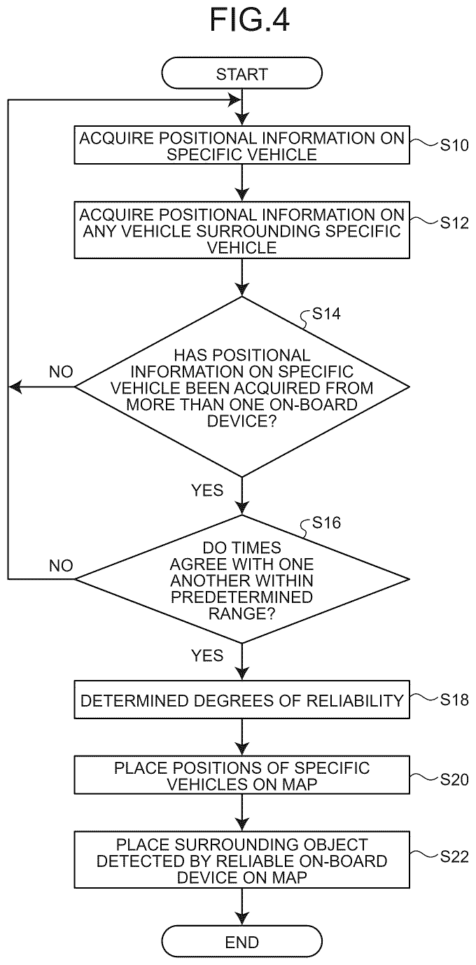

A map generation process according to the embodiment will be described by use of FIG. 4. FIG. 4 is a flowchart illustrating a flow of the map generation process according to the embodiment.

FIG. 4 illustrates a flow of a process of generating a dynamic map on the basis of information acquired by the map generation device 12 from the on-board devices 10.

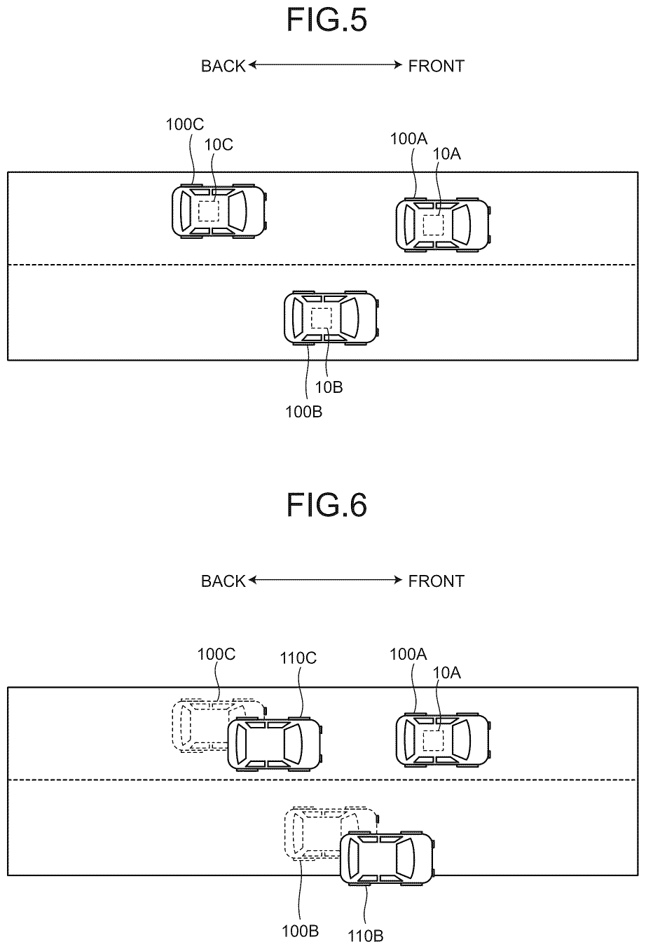

The information acquisition unit 60 acquires positional information on specific vehicles (Step S10). FIG. 5 is a diagram illustrating a method of acquiring vehicle information, according to the embodiment. In FIG. 5, a direction toward “front” illustrated therein is a traveling direction of vehicles and a direction toward “back” illustrated therein is a direction opposite to the traveling direction of the vehicles. As illustrated in FIG. 5, for example, it is now supposed that a vehicle 100A, a vehicle 100B, and a vehicle 100C are traveling on a road. The vehicle 100A has an on-board device 10A mounted therein. The vehicle 100B has an on-board device 10B mounted therein. The vehicle 100C has an on-board device 10C mounted therein. The on-board device 10A, the on-board device 10B, and the on-board device 10C have the same configuration as the on-board device 10 illustrated in FIG. 2. The on-board device 10A, the on-board device 10B, and the on-board device 10C may respectively have different levels of detection accuracy for positions of their specific vehicles and different levels of detection accuracy for positions of surrounding vehicles. In this case, the information acquisition unit 60 acquires positional information on the vehicle 100A detected by the on-board device 10A from the on-board device 10A. The information acquisition unit 60 acquires positional information on the vehicle 100B detected by the on-board device 10B from the on-board device 10B. The information acquisition unit 60 acquires positional information on the vehicle 100C detected by the on-board device 10C from the on-board device 10C. The flow is then advanced to Step S12.

The information acquisition unit 60 acquires positional information on vehicles surrounding the specific vehicles (Step S12). Reference will now be made to FIG. 5 again. The information acquisition unit 60 acquires positional information on the vehicle 100B and positional information on the vehicle 100C, both acquired by the on-board device 10A, from the on-board device 10A. The information acquisition unit 60 acquires positional information on the vehicle 100A and positional information on the vehicle 100C, both acquired by the on-board device 10B, from the on-board device 10B. The information acquisition unit 60 acquires positional information on the vehicle 100A and positional information on the vehicle 100B, both acquired by the on-board device 10C, from the on-board device 10C. The flow is then advanced to Step S14.

In the flow illustrated in FIG. 4, the information acquisition unit 60 does not necessarily acquire positional information on specific vehicles and positional information on vehicles surrounding the specific vehicles from the plural on-board devices 10 at Step S10 and Step S12.

The reliability determination unit 62 determines whether or not positional information on a specific vehicle has been acquired from on-board devices mounted in plural surrounding vehicles (Step S14). Reference will now be made to FIG. 5 again. As for the vehicle 100A, the reliability determination unit 62 determines whether or not the positional information on the vehicle 100A has been acquired from both the on-board device 10B and the on-board device 10C. As for the vehicle 100B, the reliability determination unit 62 determines whether or not the positional information on the vehicle 100B has been acquired from both the on-board device 10A and the on-board device 10C. As for the vehicle 100C, the reliability determination unit 62 determines whether or not the positional information on the vehicle 100C has been acquired from both the on-board device 10A and the on-board device 10B. In a case where it is determined that positional information on a specific vehicle has been acquired from on-board devices mounted in plural surrounding vehicles (Step S14; Yes), the flow is advanced to Step S16. In a case where it is determined that positional information on a specific vehicle has not been acquired from on-board devices mounted in plural surrounding vehicles (Step S14; No), the flow is advanced to Step S10.

In a case where “Yes” is a result of the determination at Step S14, the reliability determination unit 62 determines whether or not a time that the positional information on the specific vehicle was detected and times that the vehicles surrounding the specific vehicle detected the positional information on the specific vehicle agree with each other within a predetermined range (Step S16). This predetermined range is a predetermined time range. Specifically, the reliability determination unit 62 determines whether or not the time that the on-board device 10A detected the vehicle 100A and the time that each of the on-board device 10B and the on-board device 10C detected the vehicle 100A agree with each other within the predetermined range. The reliability determination unit 62 determines whether or not the time that the on-board device 10B detected the vehicle 100B and the time that each of the on-board device 10A and the on-board device 10C detected the vehicle 100B agree with each other within the predetermined range. The reliability determination unit 62 determines whether or not the time that the on-board device 10C detected the vehicle 100C and the time that each of the on-board device 10A and the on-board device 10B detected the vehicle 100C agree with each other within the predetermined range. The predetermined range may be changed according to traveling states of the vehicles. For example, in a case where all of the vehicles 100A to 100C have stopped, the predetermined range is set widely, for example, at several seconds. For example, in a case where any of the vehicles 100A to 100C is traveling at high speed, the predetermined range is set narrowly, for example, at several milliseconds. In a case where it has been determined that the time that the positional information on the specific vehicle was detected and the time that the vehicle surrounding the specific vehicle detected the positional information on the specific vehicle agree with each other (Step S16; Yes), the flow is advanced to Step S18. In a case where it has been determined that the time that the positional information on the specific vehicle was detected and the time that the vehicle surrounding the specific vehicle detected the positional information on the specific vehicle do not agree with each other (Step S16; No), the flow is advanced to Step S10.

However, in the case where it has been determined that the time that the positional information on the specific vehicle was detected and the time that the vehicle surrounding the specific vehicle detected the positional information on the specific vehicle do not agree with each other (Step S16; No), if a process of predicting a position of the specific vehicle and a position of the surrounding vehicle on the basis of traveling velocities of the vehicles has been performed, the flow may be advanced to Step S18 without being advanced to Step S10.

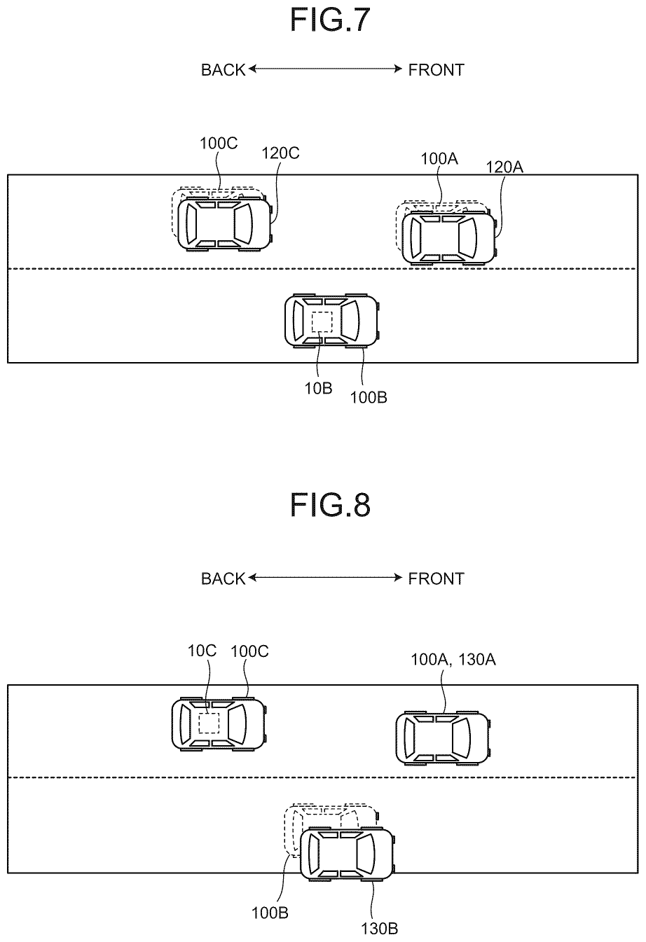

In a case where a result of the determination at Step S16 is Yes, the reliability determination unit 62 determines degrees of reliability of the on-board devices (Step S18). The reliability determination unit 62 determines a degree of reliability of each of the on-board devices on the basis of a degree of agreement between the positional information on the specific vehicle detected by the on-board device mounted in the specific vehicle and the positional information on the specific vehicle detected by the on-board device mounted in the surrounding vehicle. FIG. 6, FIG. 7, and FIG. 8 are each a diagram illustrating a method of calculating a difference between pieces of positional information, according to the embodiment.

FIG. 6 is a diagram illustrating a result of detection of positional information on vehicles surrounding the on-board device 10A. A detected vehicle 110B indicates a position of the vehicle 100B detected by the on-board device 10A. A detected vehicle 110C indicates a position of the vehicle 100C detected by the on-board device 10A.

FIG. 7 is a diagram illustrating a result of detection of positional information on vehicles surrounding the on-board device 10B. A detected vehicle 120A indicates a position of the vehicle 100A detected by the on-board device 10B. A detected vehicle 120C indicates a position of the vehicle 100C detected by the on-board device 10B. FIG. 8 is a diagram illustrating a result of detection of positional information on vehicles surrounding the on-board device 10C. A detected vehicle 130A indicates a position of the vehicle 100A detected by the on-board device 10C. A detected vehicle 130B indicates a position of the vehicle 100B detected by the on-board device 10C.

In reference to FIG. 6 to FIG. 8, as illustrated in FIG. 6, the positions of the detected vehicle 130B and the detected vehicle 130C, both detected by the on-board device 10A, respectively have large differences from the position of the vehicle 100B detected by the on-board device 10B and the position of the vehicle 100C detected by the on-board device 10C. In this case, the reliability determination unit 62 determines that the degree of reliability of the on-board device 10A is low. Specifically, in a case where a distance between positional information on a specific vehicle detected by the on-board device mounted in the specific vehicle and the positional information on the specific vehicle detected by an on-board device mounted in a surrounding vehicle is larger than one meter, the degree of reliability of the latter on-board device is determined to be low.

In reference to FIG. 6 to FIG. 8, as illustrated in FIG. 7, the positions of the detected vehicle 120A and detected vehicle 120C, both detected by the on-board device 10B, respectively have small differences from the position of the vehicle 100A detected by the on-board device 10A and the position of the vehicle 100C detected by the on-board device 10C. In this case, the reliability determination unit 62 determines that the degree of reliability of the on-board device 10B is high. Specifically, in a case where a distance between the positional information on a specific vehicle detected by the on-board device mounted in the specific vehicle and the positional information on the specific vehicle detected by an on-board device mounted in a surrounding vehicle is less than one meter, the degree of reliability of the latter on-board device is determined to be high.

In reference to FIG. 6 to FIG. 8, as illustrated in FIG. 8, the position of the detected vehicle 130A detected by the on-board device 10C agrees with the position of the vehicle 100A detected by the on-board device 10A. The position of the detected vehicle 130B detected by the on-board device 10C has a comparatively large difference from the position of the vehicle 100B detected by the on-board device 10B. In this case, the reliability determination unit 62 may determine degrees of reliability for different directions with respect to the on-board device 10C. In the example illustrated in FIG. 8, if the right side as viewed in the traveling direction that is the direction toward “front” illustrated therein is referred to as the rightward direction, the reliability determination unit 62 determines that degree of reliability for the forward direction of the on-board device 10C has the highest degree of reliability among the on-board device 10A, the on-board device 10B, and the on-board device 10C and a comparatively low degree of reliability for the rightward direction of the on-board device 10C being among the on-board device 10A, the on-board device 10B, and the on-board device 10C. The reliability determination unit 62 may, for example, determine a degree of reliability for each of the forward direction, the backward direction, the leftward direction, and the rightward direction. The reliability determination unit 62 may determine a degree of reliability for only one specific direction.

In the example illustrated in FIG. 6 to FIG. 8, the reliability determination unit 62 determines that the on-board device 10B has the highest degree of reliability among the on-board device 10A, the on-board device 10B, and the on-board device 10C.

The degrees of reliability of the on-board devices 10 have been described as having binary values, “high” and “low”, but the degrees of reliability are not necessarily expressed by binary values. A degree of reliability may be expressed by a score in a range of, for example, 0 to 10. In this case, the lower the score, the lower the degree of reliability, and the higher the score, the higher the degree of reliability. In a case where a degree of reliability is expressed by a score, the reliability determination unit 62 may determine the degree of reliability by using, for example, a publicly known technique of matching feature score.

The map integration unit 64 places the positions of the specific vehicles on a map (Step S20). Reference will now be made to FIG. 5 again. The map integration unit 64 integrates the positional information on the vehicle 100A detected by the on-board device 10A, with the basic map information 52a. The map integration unit 64 integrates the positional information on the vehicle 100B detected by the on-board device 10B, with the basic map information 52a. The map integration unit 64 integrates the positional information on the vehicle 100C detected by the on-board device 10C, with the basic map information 52a. That is, because subject vehicle positional information detected on the basis of GNSS signals are highly reliable, the map integration unit 64 integrates the detected positions as is with the basic map information 52a. Specifically, the vehicles are objects that continue to move and the map integration unit 64 thus integrates the positional information on the vehicle 100A to the vehicle 100C as dynamic information on a dynamic map, with the basic map information 52a, the dynamic information having been associated with time. The flow is then advanced to Step S22.

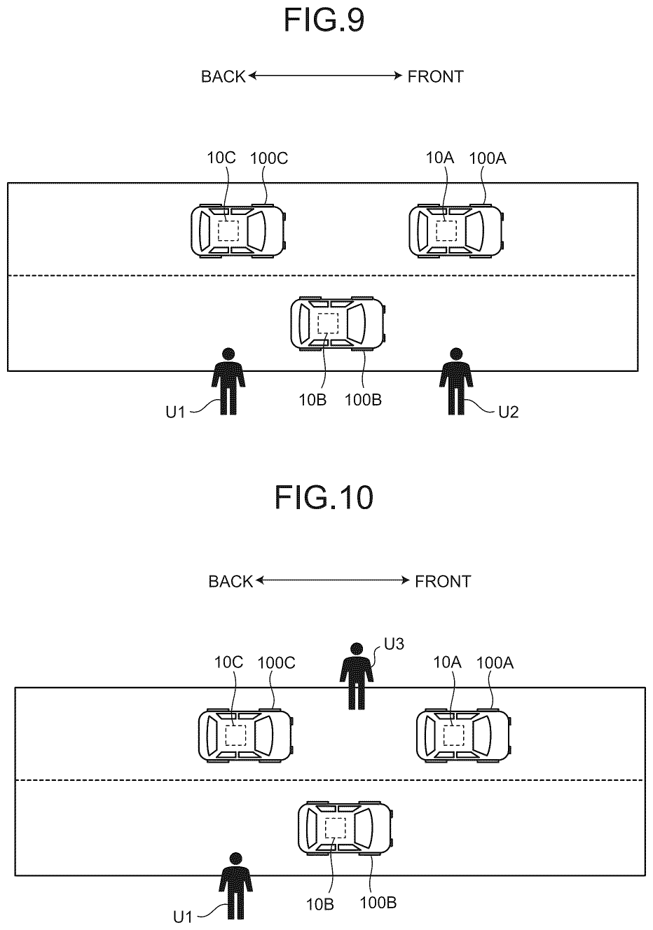

The map integration unit 64 places any surrounding object detected by an on-board device having a high degree of reliability (Step S22). FIG. 9 is a diagram illustrating a method of placing surrounding objects on a map, according to the embodiment. As illustrated in FIG. 9, it is supposed that a person U1 and a person U2 are positioned as surrounding objects around the vehicle 100A, the vehicle 100B, and the vehicle 100C. In this case, the map integration unit 64 integrates positional information on the person U1 and person U2 detected by the on-board device 10B that has been determined to have the highest degree of reliability, with the basic map information 52a. Specifically, the person U1 and person U2 are objects that continue to move and the map integration unit 64 thus integrates the positional information on the person U1 and person U2 as dynamic information on a dynamic map, with the basic map information 52a, the dynamic information having been associated with time. The surrounding objects placed on the map by the map integration unit 64 may be, not only people, but also all of moving objects moving in a region surrounding the specific vehicle, the moving objects including any of vehicles not having on-board devices 10 mounted therein, bicycles, and wheelchairs.

The map integration unit 64 may place surrounding objects detected by, not only the on-board device 10 that has been determined to have the highest degree of reliability, but also any on-board device 10 having a degree of reliability equal to or higher than a threshold that has been set at any value. For example, in a case where the degrees of reliability are expressed by scores in the range of 0 to 10, surrounding objects detected by any on-board device 10 having a degree of reliability of 8 or more are placed on the map. In this case, the same surrounding object detected by more than one of the on-board devices 10 may be placed on the map, and pieces of positional information on that object from these on-board devices 10 may differ from one another. For example, there may be a difference between the positional information on the person U1 detected by the on-board device 10C and the positional information on the person U1 detected by the on-board device 10B, in FIG. 9. In this case, the map integration unit 64 integrates, as the positional information on the person U, an intermediate position between the positional information on the person U that is detected by the on-board device 10C and the positional information on the person U that is detected by the on-board device 10B.

In a case where degrees of reliability of the plural on-board devices 10 have been set for different directions, the map integration unit 64 may place surrounding objects on the map according to the degrees of reliability for the respective directions. FIG. 10 is a diagram illustrating a method of placing surrounding objects on a map, according a modified example of the embodiment. As illustrated in FIG. 10, it is supposed, for example, that the person U1 is positioned on the right side of the vehicle 100B and vehicle 100C, and a person U3 is positioned in front of the vehicle 100C. In this case, the map integration unit 64 may place the positional information on the person U1 detected by the on-board device 10B determined to have a high degree of reliability among the on-board devices 10A to 10C by the reliability determination unit 62, on the map. However, as to the positional information on the person U3, the map integration unit 64 may place positional information on the person U3 detected by the on-board device 10C determined to have the highest degree of reliability for the forward direction among the on-board devices 10A to 10C by the reliability determination unit 62, on the map. The accuracy of the map is thereby able to be improved even further.

As described above, according to the embodiment, degrees of reliability of on-board devices respectively mounted in a specific vehicle and surrounding vehicles surrounding the specific vehicle are determined, and positional information on any surrounding object detected by an on-board device having a high degree of reliability is integrated as dynamic information on a dynamic map, with map data. The embodiment thereby enables an accurate map to be generated for an environment where surrounding vehicles are present even in a case where no surrounding objects recognizable as landmarks are available.

### Modified Example of Embodiment

The following description is on another modified example of the embodiment. According to the above description of the embodiment, positional information on a specific vehicle having an on-board device mounted therein is detected on the basis of GNSS signals and is thus accurate. However, in a case where the time traveled is short or in a situation where a straight line is maintained, it is presumed that even the degree of reliability for the position of the specific vehicle is reduced.

In a modified example of the embodiment, a controller 30 of an on-board device 10 may determine whether or not a level of accuracy of a position of a specific vehicle detected by a subject vehicle position detector 44 is higher than a predetermined threshold. In a case where the time traveled is less than a predetermined time period, or the specific vehicle has continued to travel along a straight line for a predetermined time period or more, for example, the controller 30 of the on-board device 10 determines that the level of accuracy of the position of the specific vehicle detected by the subject vehicle position detector 44 is less than the predetermined threshold. In this case, if the level of accuracy of the position of the specific vehicle has been determined to be less than the threshold, the communication controller 48 may refrain from transmitting the positional information on the specific vehicle to the map generation device 12. Any positional information having a level of accuracy less than the threshold will thereby be prevented from being used in generation of a dynamic map and degradation of accuracy of the dynamic map is thereby able to be prevented.

The determination by the controller 30 of the on-board device 10 may be performed by the controller 54 of the map generation device 12, the determination being on whether the level of accuracy of the position of the specific vehicle detected by the subject vehicle position detector 44 is higher than the predetermined threshold. In this case, if the level of accuracy of the positional information on the specific vehicle detected by the subject vehicle position detector 44 has been determined to be less than the threshold, the map integration unit 64 does not integrate that positional information with the basic map information 52a. The accuracy of the dynamic map is thereby prevented from being degraded.

Each component of the devices and devicees has been functionally and/or conceptually illustrated in the drawings, and is not necessarily configured physically as illustrated in the drawings. That is, specific modes of distribution or integration of the devices and devicees are not limited to those illustrated in the drawings, and all or part thereof may be configured to be distributed or integrated functionally or physically in any units according to various loads and use situations. Such configuration through distribution or integration may be implemented dynamically.

An embodiment of the present disclosure has been described hereinbefore, but the present disclosure is not to be limited by the embodiment. The components described above include those readily anticipated by persons skilled in the art, those that are substantially the same, and those of so-called equivalent scope. Furthermore, the above described components may be combined with one another as appropriate. Furthermore, without departing from the gist of the embodiment described above, various omissions, substitutions, or modifications of the components may be made.

The present disclosure includes subject matter contributing to implementation of “industry, technology, and infrastructure” of Sustainable Development Goals (SDGs) and to value creation by IoT solutions.

The present disclosure enables an accurate map to be generated even in a case where objects recognizable as landmarks are unavailable.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A map generation device, comprising:
an information acquisition unit that acquires positional information on a specific vehicle and positional information on surrounding vehicles that are positioned around the specific vehicle from on-board devices that are arranged respectively on the specific vehicle and the surrounding vehicle, respectively;
a map integration unit that integrates an information being on a surrounding object and having been acquired from the on-board device determined on the basis of degrees of agreement between the positional information on the specific vehicles detected by the on-board devices mounted in the specific vehicles and the positional information on the specific vehicles detected by the on-board devices mounted in the surrounding vehicles.

2. The map generation device according to claim 1, comprising,
a reliability determination unit that determines a degree of reliability of each of the on-board devices on the basis of degrees of agreement between the positional information on the specific vehicles detected by the on-board devices mounted in the specific vehicles and the positional information on the specific vehicles detected by the on-board devices mounted in the surrounding vehicles;
wherein the map integration unit that integrates positional information with a map, the information being on a surrounding object and having been acquired from the on-board device determined on the basis of the degrees of reliability, the determined on-board device being among the on-board devices.

3. The map generation device according to claim 2, wherein the map integration unit integrates positional information with the map, the positional information being on a surrounding object acquired from the on-board device having the highest degree of reliability.

4. The map generation device according to claim 2, wherein the map integration unit integrates positional information with the map, the positional information being on a surrounding object acquired from the on-board device having the degree of reliability higher than a predetermined threshold.

5. The map generation device according to any one of claims 2, wherein
the reliability determination unit determines degrees of reliability for each direction with respect to the on-board devices on the basis of degrees of agreement between the positional information on the specific vehicles detected by the on-board devices mounted in the specific vehicles and the positional information on the specific vehicles detected by the on-board devices mounted in the surrounding vehicles; and
the map integration unit integrates the positional information on the surrounding object with the map on the basis of the degrees of reliability for each direction.

6. The map generation device according to claim 1,
wherein the map integration unit maps the information being on a surrounding object as a dynamic object data, and
the information being on a surrounding object acquires from the on-board devices which is determined on the basis of degrees of agreement between the positional information on the specific vehicles which detected by the on-board devices mounted on the specific vehicles and the positional information on the specific vehicles detected by the on-board devices mounted on the surrounding vehicles.

7. A map generation method, comprising:
acquiring positional information on a specific vehicle and positional information on surrounding vehicles that are positioned around the specific vehicle from on-board devices that are arranged respectively on the specific vehicle and the surrounding vehicle, respectively;
integrating an information being on a surrounding object and having been acquired from the on-board device determined on the basis of degrees of agreement between the positional information on the specific vehicles detected by the on-board devices mounted in the specific vehicles and the positional information on the specific vehicles detected by the on-board devices mounted in the surrounding vehicles.
